(19) United States
(12) Patent Application Publication
(10) Pub. No.: US 2014/0209689 A1
(43) Pub. Date: Jul. 31, 2014

(54) SMART CARD

(71) Applicant: PRINCETON TECHNOLOGY CORPORATION, New Taipel City (TW)

(72) Inventor: Ying-Yuan Tang, New Taipei City (TW)

(73) Assignee: PRINCETON TECHNOLOGY CORPORATION, New Taipei City (TW)

(21) Appl. No.: 13/789,633

(22) Filed: Mar. 7, 2013

(30) Foreign Application Priority Data
Jan. 31, 2013 (TW) 102103794

(51) Int. Cl. G06K 19/077

(52) U.S. Cl. CPC G06K 19/07728
USPC 235/492

(57) ABSTRACT

A smart card includes a flexible printed circuit board, an electronic paper display panel, a flexible gate driver, a flexible source driver and an integrated circuit. The electronic paper display panel is disposed on the flexible printed circuited board. The flexible gate driver and the flexible source driver are formed by thin film transistors and are disposed on the electronic paper display panel. The integrated circuit is disposed on the flexible printed circuit board for providing control signals to the flexible gate driver and the flexible source driver.

### BACKGROUND OF THE INVENTION

1. Field of the Invention

The present invention is related to a smart card, and more particularly, to a flexible smart card.

2. Description of the Prior Art

A smart card is also called an integrated circuit card (IC card), which is a plastic card encasing an integrated circuit capable of storing, encoding, and processing data and can be used in a variety of applications such as identity IC cards or traffic tickets. An electronic tag is a mobile identity verification device having wireless communication and information storage functions.

The driving circuit of a dot-matrix electronic paper display panel in the smart card or the electronic tag is currently made of silicone material. One of the physical properties of silicone material is that the silicone material may crack if external forces applied to it deform it beyond the limit of physical properties of silicone material, which may result in malfunction of the driving circuit made of silicone material. Thus the folding angle of the smart card or the electronic tag is limited to a certain angle; otherwise the smart card or the electronic tag may be damaged. Usually, the electronic paper display panel and the driving circuit thereof in the smart card or the electronic tag are two distinct components coupled by wires. That is, although the electronic paper display panel is flexible, it still cannot be folded more than a certain angle because the driving circuit of it is made of silicone material, which limits the folding angle of the smart card or the electronic tag and is one of the reasons why sizes of most smart cards or electronic tags are no bigger than the size of a credit card, so as to protect them from being damaged by over folding. However as the size of the electronic paper display panel in the smart card or the electronic tag increases, the length of the driving circuit thereof must increase as well. Due to the physical properties of silicone material, the lengthened driving circuit of the bigger size electronic paper display panel may be damaged by over folding, which limits the size of the smart card or the electronic tag and further limits applications of the smart card or the electronic tag.

### SUMMARY OF THE INVENTION

An embodiment of the present invention discloses a flexible smart card. The flexible smart card comprises a flexible printed circuit board, an electronic paper display panel, a flexible gate driver, a flexible source driver, and an integrated circuit. The electronic paper display panel is disposed on the flexible printed circuit board. The flexible gate driver is formed by thin film transistors and is disposed on and coupled to the electronic paper display panel for providing gate driving signals to the electronic paper display panel. The flexible source driver is formed by thin film transistors and is disposed on and coupled to the electronic paper display panel for providing source driving signals to the electronic paper display panel. The integrated circuit is disposed on the flexible printed circuit board and is coupled to the flexible gate driver and the flexible source driver for providing control signals to the flexible gate driver and the flexible source driver.

The flexible gate driver and the flexible source driver of the present invention can be folded and folding angles thereof are not limited by physical properties of silicone material. That is to say, even if the lengths of the said drivers have been extended, the said drivers will not be damaged when being folded more than a certain angle. Therefore the electronic paper display panel's size and the smart card's size can be made bigger so as to broaden applications of the smart card.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a smart card according to an embodiment of the present invention.

FIG. 2 is a block diagram illustrating the smart card of FIG. 1.

### DETAILED DESCRIPTION

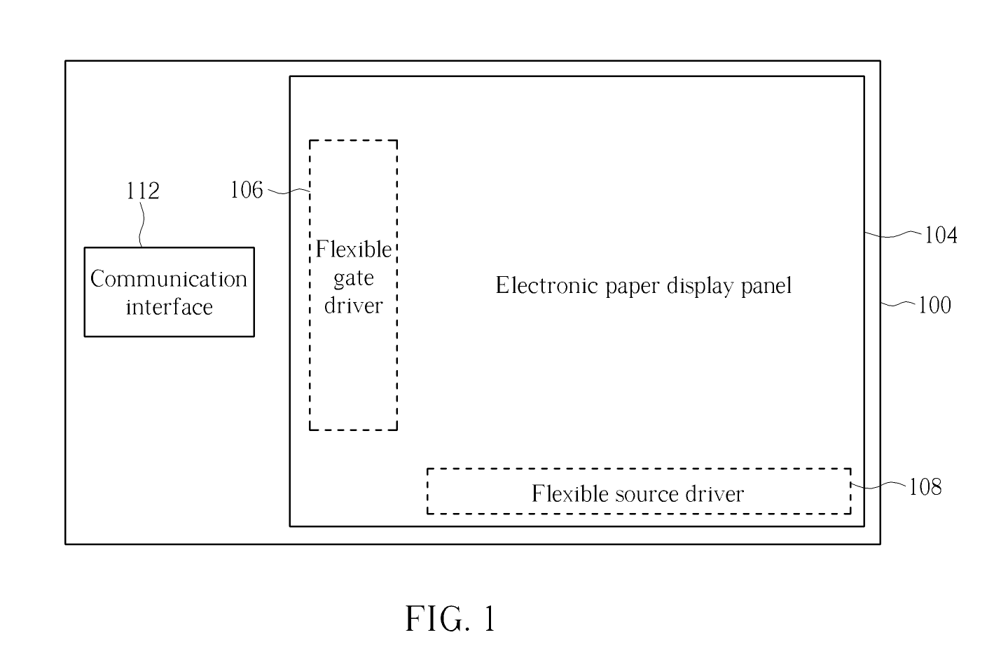

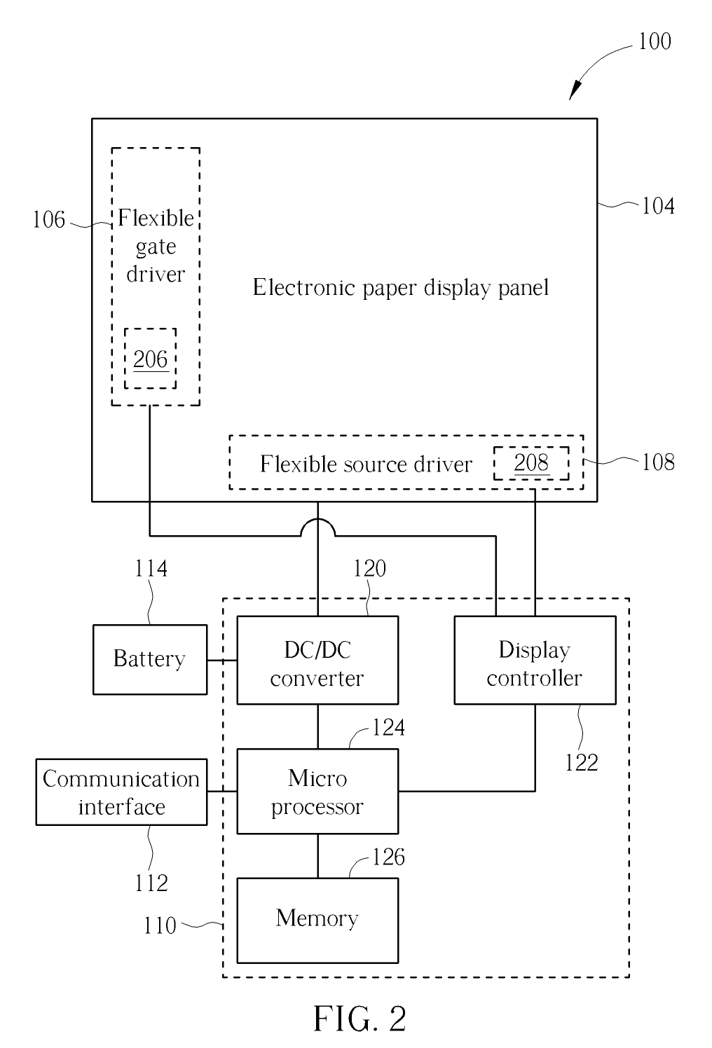

Please refer to FIG. 1 and FIG. 2. FIG. 1 is a diagram illustrating a smart card 100 according to an embodiment of the present invention. FIG. 2 is a block diagram illustrating the smart card 100 of FIG. 1. The smart card 100 may include an electronic paper display panel 104, a flexible gate driver 106, a flexible source driver 108, a communication interface 112, an integrated circuit 110, and a battery 114. The flexible gate driver 106 and the flexible source driver 108 are coupled to and disposed on the electronic paper display panel 104. The electronic paper display panel 104, the communication interface 112, the integrated circuit 110, and the battery 114 may be disposed on a flexible printed circuit board and may be encased in a flexible plastic housing.

The electronic paper display panel 104 may be a Gyricon display panel or an electrophoretic display panel. The flexible gate driver 106 is for providing gate driving signals to the electronic paper display panel 104. The flexible gate driver 106 may include a first flexible latch 206. The flexible gate driver 106 and the first flexible latch 206 are formed by thin film transistors disposed directly on the electronic paper display panel 104 instead of being made of silicone material which will be coupled to the electronic paper display panel 104 by wires after being made. So the flexible gate driver 106 and the first flexible latch 206 are not limited by physical properties of silicone material. Even if the length of the flexible gate driver 106 has been extended to fit the electronic paper display panel 104 with bigger size, the lengthened flexible gate driver 106 can be folded without being damaged because the folding angle thereof is not limited by the physical properties of silicone material. That is, the folding angle of the flexible gate driver 106 of the present invention may be much greater than that of the driving circuit made of silicone material mentioned in the prior art. Similarly, the flexible source driver 108 is for providing source driving signals to the electronic paper display panel 104. The flexible source driver 108 may include a second flexible latch 208. The flexible source driver 108 and the second flexible latch 208 are formed by thin film transistors and disposed directly on the electronic paper display panel 104 instead of being made of silicone material which will be coupled to the electronic paper display panel 104 by wires after being made. So the flexible source driver 108 and the second flexible latch 208 are not limited by physical properties of silicone material. Even if the length of the flexible source driver 108 has been extended to fit the electronic paper display panel 104 with bigger size, the lengthened flexible source driver 108 can be folded without being damaged because the folding angle thereof is not limited by the physical properties of silicone material. That is, the folding angle of the flexible source driver 108 of the present invention is much greater than that of the driving circuit made of silicone material mentioned in the prior art. The thin film transistors used to form the flexible gate driver 106 and the flexible source driver 108 in this embodiment may be P-type or N-type thin film transistors.

The battery 114 may be a flexible battery, which is coupled to the integrated circuit 110 for providing power to the integrated circuit 110. The integrated circuit 110 is coupled to the flexible gate driver 106 and the flexible source driver 108 for providing control signals to the flexible gate driver 106 and the flexible source driver 108. The integrated circuit 110 may include a DC/DC converter 120, a display controller 122, a micro processor 124, and a memory 126. The DC/DC converter 120 is coupled to the battery 114 for converting the power provided by the battery 114. The display controller 122 is coupled to the flexible gate driver 106 and the flexible source driver 108 for providing the control signals to the flexible gate driver 106 and the flexible source driver 108. The microprocessor 124 is coupled to the display controller 122, the DC/Dc converter 110, and the communication interface 112 for communicating with other devices via the communication interface 112, processing data, and controlling the display controller 122. The memory 126 is coupled to the microprocessor 124 for storing data.

Embodiments of the present invention is not limited to the embodiment of smart card 100 mentioned hereinbefore, the flexible gate driver 106, the flexible source driver 108, the first flexible latch 206, and the second flexible latch 208 may be adapted for use in an electronic tag.

In summary, the flexible gate driver, the flexible source driver, and the flexible latches of the present invention are formed by thin film transistors disposed directly on the electronic paper display panel of the smart card or the electronic tag in the manufacturing process of the electronic paper display panel (includes Gyricon display panel or electrophoretic display panel) instead of being made of silicone material which will be coupled to the electronic paper display panel by wires after being made. Thus it is an advantage that the flexible gate driver, the flexible source driver, and the flexible latches of the present invention can be folded without being damaged because the folding angle thereof is not limited by the physical properties of silicone material. That is, even if the length of the flexible gate driver or the flexible source driver has been extended, the lengthened flexible gate driver can be folded without being damaged, so they can pass the smart card bending test. Further since the flexible gate driver, the flexible source driver, and the flexible latches may be made without using silicone material, extra manufacturing processes for drivers made of silicone material may be eliminated, which is more convenient. As a result, sizes of the electronic paper display panel, the smart card, and the electronic tag may be made bigger so as to broaden applications of the smart card or the electronic tag.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A smart card comprising:
a flexible printed circuit board;
an electronic paper display panel disposed on the flexible printed circuit board;
a flexible gate driver formed by thin film transistors disposed on and coupled to the electronic paper display panel for providing gate driving signals to the electronic paper display panel;
a flexible source driver formed by thin film transistors disposed on and coupled to the electronic paper display panel for providing source driving signals to the electronic paper display panel; and
an integrated circuit disposed on the flexible printed circuit board and coupled to the flexible gate driver and the flexible source driver for providing control signals to the flexible gate driver and the flexible source driver.

2. The smart card of claim 1 wherein the flexible gate driver comprises a first flexible latch formed by thin film transistors.

3. The smart card of claim 2 wherein the flexible gate driver, the flexible source driver, and the first flexible latch are formed by P-type or N-type thin film transistors.

4. The smart card of claim 1 wherein the flexible source driver comprises a second flexible latch formed by thin film transistors.

5. The smart card of claim 4 wherein the flexible gate driver, the flexible source driver, and the second flexible latch are formed by P-type or N-type thin film transistors.

6. The smart card of claim 1 further comprising a communication interface disposed on the flexible printed circuit board and coupled to the integrated circuit.

7. The smart card of claim 6 further comprising a battery disposed on the flexible printed circuit board and coupled to the integrated circuit for providing power.

8. The smart card of claim 7 wherein the battery is a flexible battery.

9. The smart card of claim 7 wherein the integrated circuit comprises:
a DC/DC converter coupled to the battery for converting power provided by the battery;
a display controller coupled to the flexible gate driver and the flexible source driver for providing control signals to the flexible gate driver and the flexible source driver;
a microprocessor coupled to the display controller, the DC/DC converter and the communication interface for processing data ; and
a memory coupled to the microprocessor for storing data.

10. The smart card of claim 1 further comprising a flexible plastic housing for encasing the flexible printed circuit board, the electronic paper display panel, the flexible gate driver, the flexible source driver, and the integrated circuit.
